(19) United States
(12) Patent Application Publication
(10) Pub. No.: US 2008/0240605 A1
(43) Pub. Date: Oct. 2, 2008

(54) Image Processing Apparatus, Image Processing Method, and Image Processing Program

(75) Inventor: Takayuki Enjuji, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/057,273

(22) Filed: Mar. 27, 2008

(30) Foreign Application Priority Data
Mar. 27, 2007 (JP) 2007-082044

(51) Int. Cl. G06K 9/40; G06K 9/00; H04N 5/235

(52) U.S. Cl. 382/274; 382/167; 348/223.1; 348/222.1; 348/E05.042

(57) ABSTRACT

An image processing apparatus performs correction processing on image data. A night scene judgment unit judges whether an image represented by the image data is a night scene image. A correction unit performs correction on the image data by relatively strengthening a degree of expansion of luminosity range of the image data that is judged as being a night scene image by the night scene judgment unit in comparison with image data that is judged as not being a night scene image, so that the brightness range of the image data is enlarged.

### BACKGROUND

1. Technical Field

The present invention relates to an image processing apparatus, image processing method, and image processing program that perform correction processing on image data.

2. Related Art

In the field of image processing, it is desirable to perform image processing appropriately according to the scene expressed by the image that is to undergo the image processing. For example, when the image data expresses a night scene image, image correction processing may be performed to express the night scene image more beautifully. JP-A-2003-115998 discloses an image processing apparatus that determines and performs the contents of processing such as contrast correction and brightness correction on the basis of object pixels in image data.

Here, when the image data expresses an only dark picture from the result of analysis of the image data, if correction processing that is suitable for a night scene image is performed with respect to the image data, a desirable result might not necessarily be obtained. This is because pictures exist that are dark pictures as a whole but are not night scenes, such as pictures photographed under backlight conditions. That is, when correction processing is given to dark pictures, different optimal correction processing should be applied to dark pictures attributable to a night scene and to a backlight condition, respectively. When the selection of correction processing is mistaken, there is a problem that an optimal correction result is not obtained. Moreover, the image processing apparatus of JP-A-2003-115998 is also inadequate for a structure that obtains an optimal correction result for a night scene image.

### SUMMARY

The invention provides an image processing apparatus, method and program that performs optimum correction processing with respect to both a night scene image and an image that is not a night scene image.

According to one aspect of the invention, an image processing apparatus is provided that corrects image data. The image processing apparatus includes a night scene judgment unit that judges whether an image represented by the image data is a night scene image. The image processing apparatus further includes a correction unit that corrects the image data by relatively strengthening a degree of expansion of luminosity range of image data that is judged as being a night scene image in comparison with image data judged as not being a night scene image by the night scene judgment unit, so that the brightness range of the image data is expanded.

A night scene image may easily become the quality of image that a user likes by more vividly expressing a portion (a point light source and an illuminating portion) that should be originally bright in a picture. For that purpose, it is suitable to perform processing of expanding the width of the luminosity distribution of a picture. According to this invention, the night scene image is corrected appropriately when the image data expresses a night scene image since the image data is corrected by strengthening the degree of expansion of the luminosity range in comparison with image data that does not express a night scene image.

Although there can be various night scene image judgment techniques, as an example, a night scene image may be judged in a manner such that the night scene judgment unit acquires statistics for every predetermined components in the inputted image data, computes an index indicating the degree of night scene-likeness on the basis of the statistics, and judges whether the image data is a night scene image according to the index. With such a structure, it is possible to judge whether the image data is a night scene image with a certain amount of accuracy according to the feature of images for every image data that is to undergo the correction processing. Various values, such as average value, maximum, minimum, a mode, and a median of various components (hue, chroma saturation, brightness, etc.) of image data can be considered as the statistics.

In the image processing apparatus, the night scene judgment unit may divide the inputted image data into a plurality of image domains and acquire the above-mentioned statistics for every divided image domain. Although each statistic may be computed for the whole picture, if the statistics are computed for every image domain of the image data, the information (statistics) of the image data required in order to judge whether the image data is a night scene can be acquired more finely. As a result, accuracy of the judgment is improved.

In the image processing apparatus, a neural network that is made to learn from preliminarily established teaching data may be built so that the neural network receives statistics with regard to certain image data and can output an index indicating a degree of night scene-likeness of the certain image data on the basis of the inputted statistics. Further, the night scene judgment unit may acquire the index by importing statistics data of the inputted image to the neural network. With such a structure, it is possible to easily and correctly judge whether image data that is to undergo correction processing is a night scene image.

In the image processing apparatus, the correction unit may perform various correction processings besides expansion of the luminosity range. For example, brightness correction that enhances or reduces the brightness of image data as a whole by a certain correction degree that depends on the brightness of the inputted image data, and color-balance correction that equalizes deviation of the distribution for every element color that constitutes the inputted image data, may be performed. In this premise, the correction unit does not perform brightness correction processing to image data judged as being a night scene image by the night scene judgment unit at all, or performs brightness correction processing by a relatively weak correction degree in comparison with image data judged as not being a night scene image. Moreover, with respect to image data judged as being a night scene image, the correction unit does not perform color-balance correction at all, or performs by a relatively weak degree of equalization in comparison with image data judged as not being a night scene image.

That is, since dark portions, such as a night sky, should still be dark when the image is a night scene image, brightness correction processing is not even performed to the night scene image or is performed by a relatively moderate correction degree. Moreover, since it is not as necessary to true up the color-balance when the image is a night scene image, color-balance correction processing is not performed or a degree of correction is weakened even when performing. As a result, as for the night scene image, it is possible to obtain the optimal correction result at which the vividness of a point light source or an illuminating portion is enhanced and the night scene-likeness is maintained.

Moreover, since expansion of the luminosity range, brightness correction, and color-balance correction are performed according to image data when the inputted image data is not a night scene image (for example, a dark picture photographed under backlight conditions), it is possible to obtain an image that is corrected appropriately.

Although the technical spirit of the invention is explained in a category of an image processing apparatus, the invention includes an image processing method including processing processes corresponding to the units of the image processing apparatus, respectively, and an image processing program that makes a computer perform functions corresponding to the units of the image processing apparatus.

### BRIEF DESCRIPTION OF THE DRAWINGS

The invention will be described with reference to the accompanying drawings, wherein like numbers reference like elements.

FIG. 1 is a block diagram illustrating an image processing apparatus according to one embodiment of the invention.

FIG. 2 is a flowchart illustrating contents of image processing.

FIG. 3 is a flowchart illustrating details of computation processing of statistics data.

FIG. 4 is a view illustrating a state in which image data is divided into a plurality of image domains.

FIG. 5 is a schematic view illustrating a structure of a neural network.

FIG. 6 is a view illustrating an example of discrimination of correction processings.

FIG. 7 is a view illustrating an example of a function for level correction.

FIG. 8 is a view illustrating an example of a function for contrast correction.

FIG. 9 is a view illustrating a correction curve for brightness correction.

FIG. 10 is a view illustrating an example of a correction amount determination function.

### DESCRIPTION OF EXEMPLARY EMBODIMENTS

Embodiments of the invention will be described in the following order:
(1) Overall structure of an image processing apparatus;
(2) Processing of image scene determination;
(3) Processing of image correction;
(3-1) Processing of correction for night scene image;
(3-2) Processing of standard correction; and
(4) Conclusion.

### (1) Overall Structure of an Image Processing Apparatus

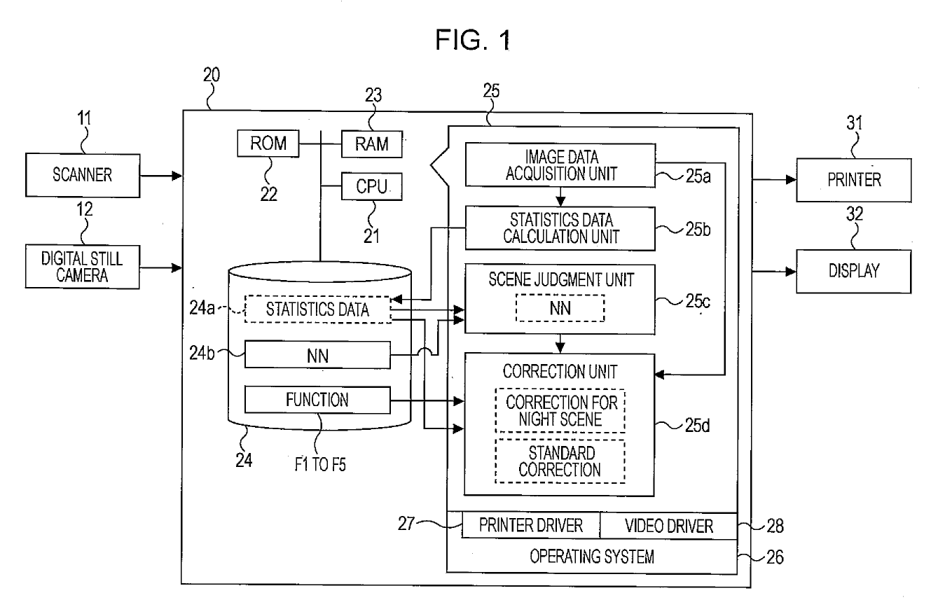

FIG. 1 is a block diagram showing the outline structure of an image processing apparatus according to one embodiment of the invention and peripheral devices of the image processing apparatus. In this figure, a computer 20 is shown as an image processing apparatus that plays the central role of image processing. The computer 20 is equipped with a central processing unit (CPU) 21, a read only memory (ROM) 22, a random access memory (RAM) 23, a hard disk (HD) 24, etc. The computer 20 is suitably connected with various kinds of image readers such as a scanner 11 and a digital still camera 12, and with various kinds of image output units such as a printer 31 and a display 32.

In the computer 20, the CPU 21 uses the RAM 23 as a work area and executes various programs stored in a predetermined storage medium such as the ROM 22 or the HD 24. With this embodiment, the CPU 21 reads and performs applications (APL) 25 stored in the HD 24. The APL 25 includes functional blocks, such as an overall block, an image data acquisition block 25a, a statistics data calculation block 25b, a scene judging block 25c, and a correction block 25d.

The image data acquisition block 25a acquires the image data outputted from the image reader and the image data saved in the HD 24 as input image data.

The statistics data calculation block 25b calculates statistics (statistics data) for every predetermined component in the input image data. The scene judging block 25c computes an index indicating the degree of night scene-likeness on the basis of each statistics data 24a calculated by the statistics data calculation block 25b and a predetermined scene automatic judging program 24b, and judges whether the input image data is a night scene image according to the index. Therefore, the statistics data calculation block 25b and the scene judging block 25c serve as a night scene judgment unit.

The correction block 25d receives the input image data from the image data acquisition block 25a, executes correction processing to the inputted image data according to the judgment result that is made by the scene judging block 25c, and outputs corrected image data that has undergone the correction processing With this embodiment, at least the correction block 25d can perform level correction processing, brightness correction processing, contrast correction processing, and color-balance correction processing. Details of each type of correction processing are described below.

In the computer 20, the APL 25 is performed in the built-in state in an operating system 26, and the operating system 26 also contains a printer driver 27 and a display driver 28. The display driver 28 controls image display to the display 32, and can display a picture on the display 32 on the basis of the corrected image data outputted from the correction block 25d of the APL 25. The printer driver 27 can make a printer 31 perform printing of a picture on the basis of printing data produced by performing color conversion processing, half-tone processing, rasterizing processing to an ink color (for example, cyan, magenta, yellow, black) color system with respect to the corrected image data that is outputted from the correction block 25d of the APL 25, and by outputting the printing data to the printer 31.

The processings performed by the computer 20 of this embodiment may be executed at the image reader side as a whole or in part, or may be performed at the image output unit side. For example, the function of the correction block 25d may be provided to the printer 31 or the display 32, and the printer 31 or the display 32 may correct the image data imported from the APL 25 and perform printing processing or image display processing on the basis of the corrected image data. In such a case, an image processing system comprises the combination of the computer 20, the printer 31, and the display 32.

### (2) Processing of Image Scene Judgment

Image correction processings that are performed using the basic structure are described in detail below.

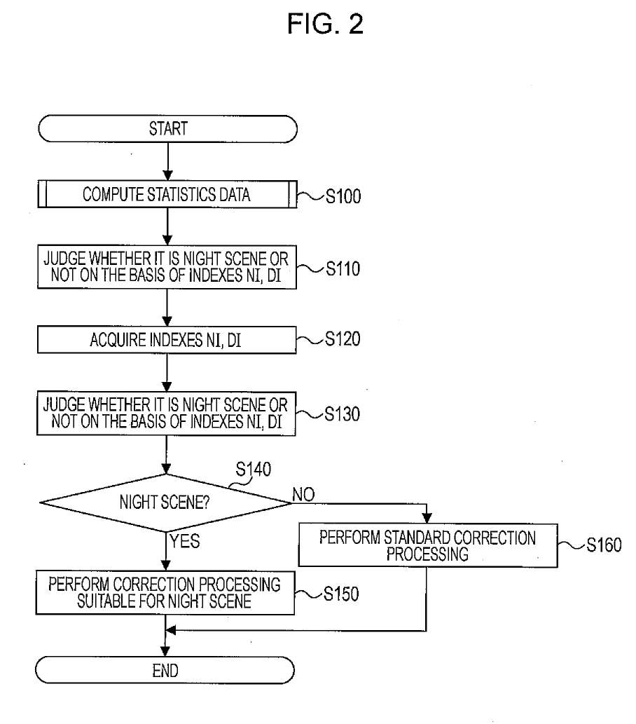

FIG. 2 is a flowchart showing part of image processing that the computer 20 performs with the APL 25 (the contents after processing performed by the statistics data calculation block 25b).

At step S100, the computer 20 extracts statistics data, such as average value and maximum, from each histogram while generating histograms for every predetermined component value and luminosity of the input image data.

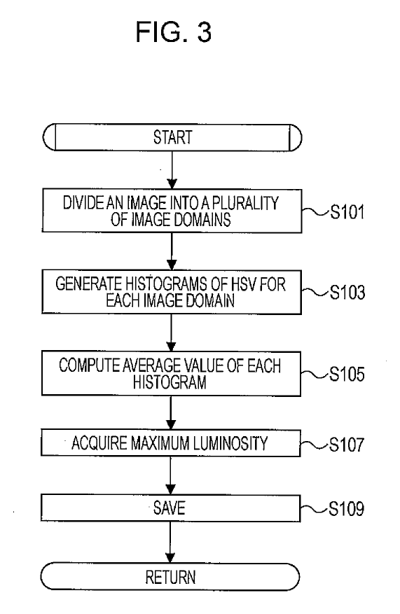

FIG. 3 is a flow chart showing the details of the processing of the step S100.

At step S101, the computer 20 divides the input image data into a plurality of image domains. With this embodiment, the input image data delivered from the image data acquisition block 25a is in the form of a dot matrix that specifies colors of respective pixels, expressed by a plurality of gray levels (256 gray levels from 0 to 255) of each of element colors R, G, and B, and uses a color system according to the sRGB standard. Of course, the input image data may be various data such as JPEG image data that uses the YCbCr color system and image data that uses the CMYK color system.

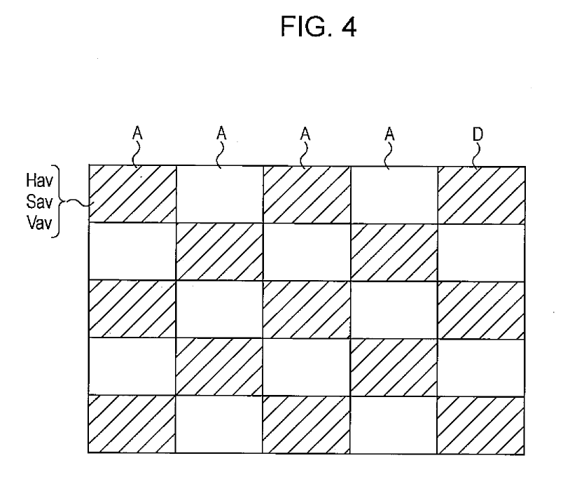

FIG. 4 shows the input image data D that is divided into a plurality of image domains A at step S101. In FIG. 4, the input image data D is divided into five image domains in horizontal and vertical directions, respectively, so that there are 25 image domains A in total. Of course, a method of dividing the input image data D is not limited to the method shown in FIG. 4.

At step S103, the computer 20 generates frequency distributions (histograms) of H, S, and V for every image domain that is obtained by division of the input image data. H (Hue) represents hue, S (Saturation) represents chroma saturation, and V (Value) represents brightness. The computer 20 specifically converts the RGB data of each pixel in the image domain that is selected as a target for histogram generation processing to HSV-format data, counts the frequency for every gradation while specifying each of H, S, and V to a predetermined gradation range (for example, 0 to 255) according to their values, and generates histograms for H, S, and V, respectively. Conversion to HSV-format data from the RGB data can be performed by a well-known conversion method. The computer 20 chooses the target image domain one by one, and performs such histogram generation processing for the target image domain.

The computer 20 can generate the histograms of H, S, and V for every image domain obtained by the division. However, with this embodiment, in order to reduce computational complexity, each of histograms of H, S, and V is generated for only some selected image domains among all the image domains obtained by the division. As shown in FIG. 4, some image domains A are hatched. With this embodiment, the histograms of H, S, and V are generated for the image domains A (for example, basically every alternate image domains A) shown by the hatching.

At step S105, the computer 20 computes the average values Hav, Sav, and Vav of the histograms generated at step S103. As a result, when there are n image domains to undergo processing of histogram generation of H, S, and V, n average values Hav, Sav, and Vav for H, S, and V are computed, respectively.

At step S107, the computer 20 acquires the maximum of the luminosity of the input image data. The maximum of luminosity is not calculated for every image domain that is divided, but is calculated for the whole picture. That is, there is only one maximum for the whole picture. In this case, the computer 20 obtains the luminosity Y of each pixel of the input image data and generates the frequency distribution (histogram) of the luminosities that are obtained. There are many methods of obtaining the luminosity Y of each pixel, but the luminosity Y may be obtained in a manner such that an RGB value of each pixel is converted to an L*a*b* value by referring to a table (it is also called a profile) that specifies the conversion relationship between the sRGB color system and the L*a*b* color system specified by the International Commission on Illumination (CIE), and the L* ingredient value that is acquired is regarded as the luminosity Y of the pertinent pixel.

On the other hand, the luminosity Y of the pixel may be obtained by computation of the known RGB weighted integration formula (1), Y=0.3R+0.59G+0.11B. With this embodiment, for simplification of processing, the luminosity Y of each pixel is acquired by the formula (1) and the histogram of luminosity is generated by counting up the luminosity Y of the pixels for every gradation.

After generation of the luminosity histogram, the computer 20 makes the maximum Ymax with a value of the upper end of the histogram (the highest gradation of the high gradation side of the histogram). However, a method other than simply taking the gradation of the high gradation side of the luminosity distribution as the maximum Ymax may be considered. For example, it is possible to take the gradation at a position that retracts by a certain distribution rate (for example, 0.5% of the number of pixels used for the total of the histogram) from the high gradation side of the histogram as the maximum Ymax. If the maximum of the histogram whose upper end portion is cut by a predetermined rate is used (upper end processing), it is possible to remove the white point attributable to noise at the high gradation side.

At step S109, the computer 20 saves every data Hav, Sav, Vav, and Ymax acquired at steps S105 and 107 as statistics data 24a in the HD 24. The computer 20 may generate each histogram on the basis of a predetermined number of selected pixels, which is determined by a predetermined sampling rate, among all the pixels in the target image domain rather than on the basis of all the pixels in the target image domain.

Moreover, with this embodiment, besides the Hav, Sav, Vav, and Ymax, various statistics data such as the average value Yav of the histogram of the luminosity, the maximums Rmax, Gmax, and Bmax, the average values Rav, Gav, and Bav, and medians Rmed, Gmed, and Bmed for every R. G, and B, can be saved in the HD 24. In this case, frequency distributions (histograms) for every R, G, and B in the input image data are generated, and generated upper ends (or upper ends after upper end processing) of the histograms for every R, G, and B can be maximums Rmax, Omax, and Bmax. The average values Rav, Gav, Bav, and medians Rmed, Omed, Bmed, are also acquired from the histograms for every R, G, and B.

This description now returns to explanation of FIG. 2.

At step S110, the computer 20 reads out the neural network (MN) 24b that is built beforehand as a cyan automatic judgment program 24b and reads from the HD 24 statistics data Hav, Sav, Vav, Ymax acquired at steps S105 and 107 among the statistics data 24a, and imports the read statistics data into the NN 24b. The NN 24b is a multi-layered perceptron-type neural network, and can output two indexes NI and DI according to the inputted statistics data. The computer 20 preliminarily downloads the NN 24b from an external server to the HD 24 thereof through a predetermined network, when it is needed to save the NN 24b beforehand in the HD 24. On the other hand, the computer 20 may read the NN 24b from the above-mentioned server in the stage of needing the NN 24b.

At step S120, the computer 20 acquires the indexes NI and DI as the output result from the NN 24b. The index NI is an index indicating night scene-likeness of the input image data that was the acquisition origin of the statistics data, and is expressed by the numerical value of from 0 to 1. The index NI means that night scene-likeness of the input image data becomes higher as it approaches the numeral value 1. On the other hand, the index DI indicates landscape-likeness of the input image data that was the extraction origin of the statistics data, and is expressed by the numerical value of from 0 to 1. The index DI means that the landscape-likeness of the input image data becomes higher as it approaches the numeral value 1. Next, the structure of the NN 24b is explained briefly.

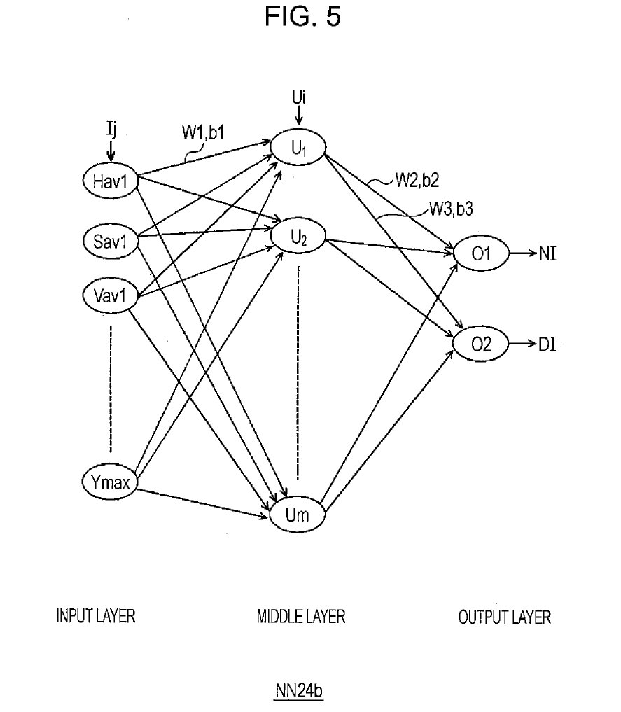

FIG. 5 shows the structure of the NN 24b. The NN 24b consists of an input layer including a plurality of input units Ij, a middle layer including a plurality of middle units Ui (i=1 to m), and an output layer including an output unit O1 that outputs the index NI and an output unit O2 that outputs the index DI. The number of the input units Ij depends on the number of statistics data that is inputted into the NN 24b. For example, when the number of the statistics data inputted into the NN 24b is 40 (13 for each of Hav, Sav, and Vav, and 1 for Ymax), j is set to j=1 to 40. In the input layer, each input unit Ij inputs one piece of statistics data.

Each middle unit Ui of the middle layer is expressed by formula (2):

### [Formula 2]

$${U}_{i} = {\sum }_{j = 1}^{40} {I}_{j} W {1}_{ij} + b {1}_{i} \qquad ( 2 )$$

As shown in the above formula (2), every middle unit Ui carries out linear combination by weighing the input values (Ij) of the input units by coefficient W1ij. The coefficient W1ij is a peculiar weighting coefficient that each middle unit Ui has with respect to each input unit Ij. Moreover, each middle unit Ui has a peculiar bias b1i, and this bias b1i is added to the linear combination of the input units Ij.

Moreover, the output units O1 and O2 of the output layer compute the indexes NI and DI by formula (3) and formula (4), respectively, in which:

### [Formula 3]

$$N I = {\sum }_{i = 1}^{m} {Z}_{i} W {2}_{i} + b 2 \qquad ( 3 )$$

### [Formula 4]

$$D I = {\sum }_{i = 1}^{m} {Z}_{i} W {3}_{i} + b 3 \qquad ( 4 )$$

The Zi is the output result from each middle unit Ui, and is expressed by formula (5), Zi=f(Ui). In formula (5), f means an input-output function of the middle layer, and is a monotone increase continuous function. As shown in the above formula (3), in the output unit O1, the output Zi of each middle unit Ui is weighed by coefficient W2i, and then the linear combination is carried out. The coefficient W2i is a peculiar weighing coefficient that the output unit O1 has with respect to each middle unit Ui. Moreover, the output unit O1 has a peculiar bias b2, and this bias b2 is added to the linear combination of Zi. Similarly, as shown in the above formula (4), the output unit O2 carries out linear combination after weighting the output Zi of each middle unit Ui by coefficient W3i. The coefficient W3i is a peculiar weighing coefficient that the output unit O2 has with respect to each middle unit Ui. Moreover, the output unit O2 has a peculiar bias b3, and this bias b3 is added to the linear combination of Zi.

The NN 24b used in this embodiment is one that is already finished learning. That is, the computer 20 provides the NN 24b before the learning with statistics data with regard to some night scene images (night scene teaching data), target outputs NI with regard to respect pieces of the night scene teaching data, statistics data with regard to some landscape images (landscape scene teaching data), and target outputs DI with regard to the respective pieces of the landscape teaching data. Then, the computer 20 performs optimization processing to coefficient W1ij, bias b1i, coefficient W2i, bias b2, coefficient W3i, and bias b3 in advance so that the target output NI and the actual output result of the output unit O1 are equal to each other, and the target output DI and the actual output result of the output unit O2 are equal to each other.

This description now returns to explanation of FIG. 2.

At step S130, the computer 20 judges whether the input image data is a night scene image on the basis of the index NI and the index DI acquired at step S120. As an example, with this embodiment, when the index NI≧0.5 and the index DI<0.5, the input image data is judged as being a night scene image.

At step S140, the processing performed by the computer 20 branches according to the above judgment result (whether it is a night scene image or not). When judged as being a night scene image, the processing flow progresses to step S150 and the computer 20 performs correction processing suitable for a night scene image. On the other hand, when judged as not being a night scene image, the processing flow progresses to step S160, and the computer 20 performs standard correction processing. Although finer judgment is possible in step S130 in a manner such that when the index NI<0.5 and the index DI≧0.5, the input image data is judged as being a landscape image, and when both indexes are not less then 0.5 or not greater than 0.5, the image data is judged as being a standard image, with this embodiment, standard correction processing is performed on images other than a night scene image.

### (3) Processing of Image Correction

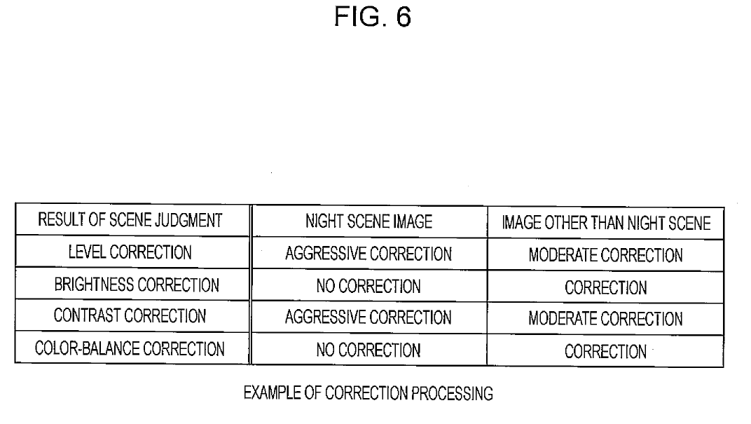

FIG. 6 is a table showing the difference of the correction processing that the computer 20 performs on an image judged as being a night scene image (processing of step S150) and the correction processing that the computer 20 performs on an image judged as not being a night scene image (processing of step S160). As described above, the computer 20 can perform level correction, brightness correction, contrast correction, and color-balance correction using the APL 25 (correction section 25d). Further, on a night scene image, the computer 20 aggressively performs level correction and contrast correction, but moderately performs brightness correction and color-balance correction. On the other hand, on images other than a night scene image, relatively moderate level correction and contrast correction are performed as compared to a night scene image but brightness correction and color-balance correction are performed to a degree that is usually performed in usual corrections. However, to a night scene image, brightness correction and color-balance correction may be performed by a degree more moderate than the correction degree performed to images other than night scene images, rather than not performing at all.

### (3-1) Correction Processing Suitable for Night Scene Image

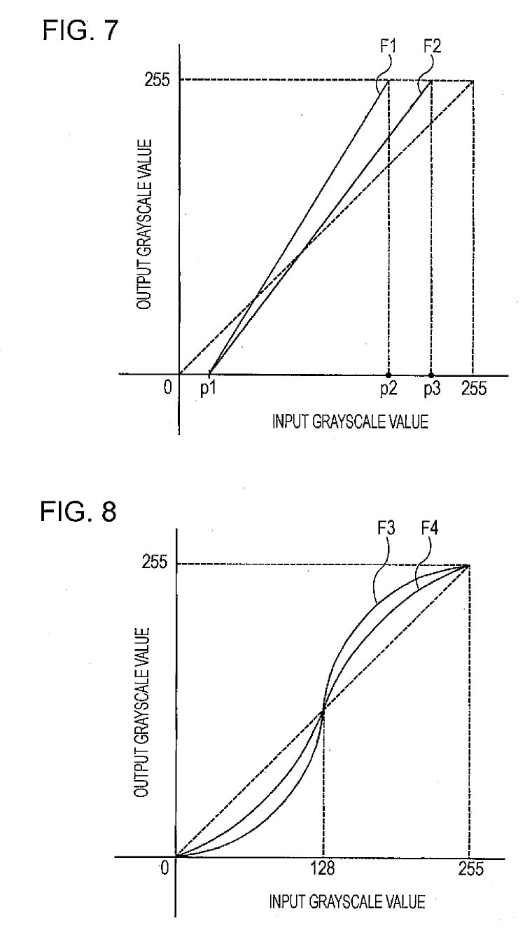

FIG. 7 shows exemplary functions F1 and F2 for the level correction. The correction mentioned in this specification means that gradation of the luminosity of each pixel of the input image data is inputted into a level correction function for correction. As shown in FIG. 7, both the functions F1 and F2 are linear functions with steeper inclinations than an inclination of the case in which input (0 to 255)=output (0 to 255). Moreover, the function F1 has a steeper inclination than the function F2. In greater detail, the function F1 corrects the output to the maximum gradation 255 of the gradation range of the luminosity when the input is not smaller than gradation p2, and the function F2 corrects the output to the maximum gradation 255 when the input is not smaller than gradation p3 (however, p3>p2).

In both the functions F1 and F2, the output=0 when the input is not larger than gradation pi (however, 0<p1<p2).

Therefore, if level correction using the function F1 or F2 is performed, the width of the luminosity range of the image data after the correction will be expanded as compared to the width of the luminosity range before the correction. As for the width, when the same image data is inputted, the luminosity range after correction using the function F1 tends to be larger than the luminosity range after correction using the function F2. Therefore, level correction using the function F1 is more aggressive than level correction using the function F2.

FIG. 8 shows functions F3 and F4 for contrast correction. Here, contrast correction means that the width of the luminosity range of the image data is expanded by inputting the gradation of the luminosity of each pixel of the input image data into a contrast correction function. As shown in FIG. 8, both the functions F3 and F4 output a value that is smaller than an input when the input is smaller than the middle gradation (128) of the gradation range of the luminosity, but output a value that is larger than the input when the input is larger than the middle gradation, and the functions F3 and F4 are curves in an approximate shape of the letter S. Moreover, the function F3 is a curve of S that is more deeply bent than the function F4 in any side of low gradation and high gradation. Therefore, as for the width, the luminosity range after correction using the function F3 tends to be larger than the luminosity range after correction using the function F4 when the same input image data is inputted. Therefore, contrast correction using the function F3 is more aggressive than contrast correction using the function F4.

At step S150, the computer 20 reads the functions F1 and F3 from a predetermined storage medium such as HD 24. Then, the computer 20 inputs the luminosity of the pixels of the input image data into the function F1, inputs a first output gradation (the result of the function F1) into the function F3, and defines a second output gradation (the result of the function F3) as luminosity after correction (i.e. corrected luminosity). Correction by the functions F1 and function F3 is carried out for all the pixels of the input image data. As a result, the luminosity range of the input image data is greatly expanded by level correction and contrast correction as compared with before correction. The order of execution of level correction and contrast correction may be contrary to the above.

Moreover, the computer 20 may preliminarily generate a correction look-up table (LUT) for night scene images, which realizes simultaneous corrections by the functions F1 and F3. That is, each input gradation of 0 to 255 (initial input gradation) is corrected by the function F1 to produce the initial correction result, and then the final correction result is acquired by inputting the initial correction result into the function F3. Then, the LUT in which the initial input gradation and the final correction result are matched is produced, and then saved in a predetermined storage medium such as the HD 24. The computer 20 can perform aggressive level correction and aggressive contrast correction by one conversion process about each pixel of the input image data by performing the correction processing of step S150 using the correction LUT for night scene images. Moreover, as mentioned above, at step S150, brightness correction and color-balance correction are not performed.

### (3-2) Standard Correction Processing

On the other hand, at the step S160, the computer 20 reads the functions F2 and F4 from the predetermined storage medium such as the HD 24 in order to perform more moderate level correction and contrast correction than the case in which the image is a picture is a night scene image. Furthermore, the computer 20 acquires the correction curve C for brightness correction and the amount of correction for the color-balance correction in order to perform brightness correction and color-balance correction.

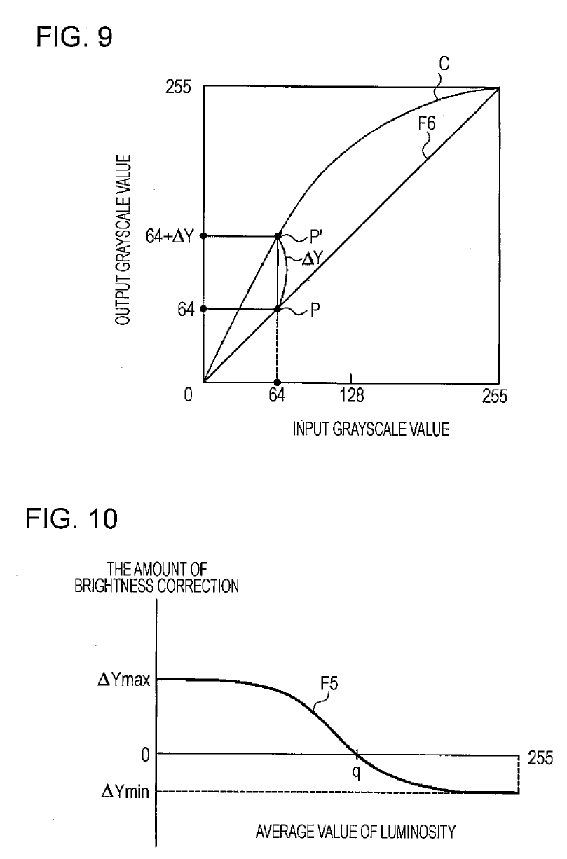

FIG. 9 shows the correction curve C for brightness correction (referred to as a tone curve). Brightness correction in this specification means correction that enhances or reduces the brightness of the image data on the whole according to the correction curve of the correction degree that depends on the brightness of the input image data.

The computer 20 determines the correction degree in the correction curve C according to the luminosity average value of the input image data, when generating the correction curve C. As mentioned above, the computer 20 computed the average value Yav of the histogram of luminosity in the step S100, and has saved it in the HD 24 as a kind of the statistics data 24a. Then, the computer 20 reads this average value Yav from the HD 24, and determines the amount of brightness correction ΔY according to the value of the luminosity average value Yav.

FIG. 10 shows an exemplary correction amount determination function F5 for determining the amount of brightness correction ΔY (hereinafter, referred to as brightness correction amount). The correction amount determination function F5 determines the brightness correction amount ΔY uniquely to the arbitrary luminosity average value Yav. In FIG. 10, a horizontal axis shows the luminosity average value Yav, and a vertical axis shows the brightness correction amount ΔY. The correction amount determination function F5 produces the maximum brightness correction amount ΔYmax when the luminosity average value Yav as an input is the minimum, and the brightness correction amount ΔY becomes smaller as the average value Yav of the luminosity becomes larger. When the luminosity average value Yav exceeds the predetermined gradation q, the brightness correction amount ΔY has a negative value, and when the luminosity average value Yav is the maximum, the brightness correction amount ΔY becomes the minimum ΔYmin. The computer 20 obtains one brightness correction amount ΔY by inputting the luminosity average value Yav into the correction amount decision function F5 while reading the correction amount decision function F5 from the predetermined storage medium such as the HD 24.

The computer 20 corrects the specific point P on the straight line graph used as the foundation of a tone curve by the brightness correction amount ΔY acquired as mentioned above, performs spline interpolation operation with reference to the after correction point and both ends of the straight line graph, and generates the tone curve by the interpolation operation. In greater detail, as shown in FIG. 9, the computer 20 performs the correction of adding the brightness correction amount ΔY to the output gradation (64) at the point P corresponding to the input gradation 64 on the straight line graph F6 in which input (0 to 255)=output (0 to 255). Then, the computer 20 computes a curve that includes a point P′ after the correction (corrected point P′) and both ends of the straight line graph F6 using spline interpolation, and lets the computed tone curve be the correction curve C. In addition, the point P used as a target for correction by the brightness correction amount AY is not limited to the position corresponding to the input gradation 64 on the straight line F2. When the acquired brightness correction amount ΔY has a positive value, a position corresponding to one input gradation at a low gradation side on the straight line graph F6 than the middle gradation (128) of the input gradation range is set as a correction target by the brightness correction amount ΔY. Conversely, when the acquired brightness correction amount ΔY has a negative value, a position corresponding to one input gradation at a high gradation side on the straight line graph F6 than the middle gradation is set to the correction target by the brightness correction amount ΔY. Moreover, as for the correction curve C, it may not simply be the above tone curve, but it may be a curve that is produced by putting the tone curve and a γ (gamma) curve having a predetermined curve form together. When putting the γ curve and the tone curve together, it is possible to determine a correction degree by the γ (gamma) curve according to the luminosity average value Yav.

Next, generation of the correction amount for color-balance correction is explained. Color-balance correction means processing that corrects a shift in a position of distribution for every element color RGB when there is a gap in the position of distribution of each element color RGB of the input image data. By performing color-balance correction, what is known as “color fogging” is correctable. There may be various concrete examples of color-balance correction processing, but following is one example in which the amount of offset that is the relative gap between element colors is calculated, and the gradation of each element color is corrected responding to this amount of offset. The computer 20 determines the gap of other colors (R, B) to one color (here, suppose that it is G) among element colors R, G, and B in the following manner, reading some statistics data 24a saved in the HD 24:

dRmax=Gmax−Rmax (6)

dBmax=Gmax−Bmax (7)

dRmed=Gmed−Rmed (8)

dBmed=Gmed−Bmed (9)

In the above formulas, dRmax and dbmax are gaps of Rmax and Bmax to Gmax of the input image data, respectively and dRmed and dbmed are gaps of Rmed and Bmed to Gmed of the input image data, respectively. The computer 20 determines the amount dR of offset for red component and the amount dB of offset for blue component as follows according to the gaps, for example:

dR=(dRmax+dRmed)/α (10)

dB=(dBmax+dBmed)/β (11)

The α and β are predetermined denominators, such as 2 and 4, and can be suitably changed by experiments.

At step S160, the computer 20 performs processing that adds the amount dR of offset to R component of each pixel and adds the amount dB of offset to B component of each pixel for all the pixels of the input image data, when the amounts dR and dB of offset are calculated as mentioned above. As a result, the relative gap of distribution of each element color RGB of the input image data is corrected with predetermined accuracy, and the color-balance is adjusted. The computer 20 performs brightness correction using the correction curve C that is generated for the input image data after color-balance correction. In this case, the luminosity of each pixel is corrected by inputting the luminosity value into the correction curve C for every pixel of the input image data. As a result, when the original brightness (luminosity average value Yav) of the input image data is low, the brightness of an image can be enhanced on the whole according to the lowness, and when the original brightness of the input image data is high, the brightness of an image is conversely reduced on the whole according to the highness. Furthermore, the computer 20 performs level correction according to the above-mentioned function F2 for the input image data after brightness correction, and performs contrast correction according to the above-mentioned function F4. The order of execution of color-balance correction, brightness correction, level correction, and contrast correction is not limited to this order.

Moreover, the computer 20 may generate the standard correction LUT that realizes simultaneously correction by the correction curve C, correction by the function F2, and correction by the function F4. That is, every input gradation of from 0 to 255 (the initial input gradation) is corrected with the correction curve C one by one, the correction results are then inputted into the function F2 to perform further correction, and the results from the function F2 are inputted into the function F4 to obtain the final correction result. Thus, an LUT is generated in which the initial input gradations and the final correction results are matched. The computer 20 can perform brightness correction, level correction for the luminosity of the input image data, and contrast correction by one conversion process of each one pixel, if the standard correction LUT is used.

The computer 20 downloads the functions F1 to F5 into the HD 24 from an external server via a predetermined network beforehand, when preserving the functions F1 to F5 and the correction LUT for the night scene images in the HD 24. Moreover, when saving them in a storage medium of an image processing apparatus such as the ROM 22, the functions are recorded beforehand in the factory-shipments stage of the image processing apparatus. Of course, other preservation places of the functions may be considered besides the above, and it may be an external recording medium that can be accessed by the computer 20. The functions may be saved at the storage medium in the image reader or the image output unit.

### (4) Conclusion

Thus, according to this invention, the Hav, Sav, Vav, and Ymax are extracted as statistics data of the input image data. The extracted statistics data is inputted into the NN 24b as a scene automatic judgment program, and it is judged whether the input image data is a night scene image according to the index NI indicating night scene-likeness and the index DI indicating landscape-likeness outputted from the NN 24b. When the image data is judged as being a night scene image, level correction and contrast correction are performed using the correction functions F1 and F3 that realize a stronger expansion degree than a standard luminosity expansion degree, and brightness correction and color-balance correction are not performed. On the other hand, when the image data is judged as not being a night scene image, level correction and contrast correction are performed using the correction functions F2 and F4 that realize a standard luminosity expansion degree (degree more moderate than the case of being a night scene image), and brightness correction and color-balance correction are performed in usual manner.

Therefore, when the input image data is a night scene image, the luminosity range of the image is expanded more greatly, so that the difference of portions that should be bright originally, such as a point light source or an illuminating portion in the image and the other dark portions is much more highly conspicuous, and a high-quality correction result is obtained. Moreover, since neither brightness correction nor color-balance correction is performed, it is not likely that a night scene portion that should be dark originally will become bright on the whole, or that the atmosphere of the original night scene will be lost by the change of the color-balance.

Moreover, when the input image is a dark picture photographed under backlight conditions rather than a night scene image, since the all of level correction, brightness correction, contrast correction, and color-balance correction are performed, the whole brightness, contrast, and color-balance optimized according to the original picture can be obtained as the correction result.

What is claimed is:

1. An image processing apparatus that performs correction processing with respect to image data, the apparatus comprising:
a night scene judgment unit that judges whether an image represented by the image data is a night scene image; and
a correction unit that performs correction to the image data by relatively strengthening a degree of expansion of luminosity range of the image data that is judged as being a night scene image by the night scene judgment unit in comparison with image data that is judged as not being a night scene image, so that the brightness range of the image data is enlarged.

2. The image processing apparatus according to claim 1, wherein the night scene judgment unit acquires statistics for every predetermined component of the image data, computes an index indicating a degree of night scene-likeness on the basis of the respective statistics, and judges whether the image data is the night scene image on the basis of the index.

3. The image processing apparatus according to claim 2, wherein the night scene judgment unit divides the image data into a plurality of image domains, and acquires statistics for every image domain.

4. The image processing apparatus according to claim 2, wherein the night scene judgment unit receives the statistics with regard to certain image data and computes an index with regard to the image data using a neural network that can output the index on the basis of the statistics.

5. The image processing apparatus according to claim 1, wherein the correction unit can perform brightness correction processing in order to enhance or reduce brightness of the inputted image data as a whole according to a correction amount that depends on the brightness of the image data, and wherein, with respect to image data that is judged as being a night scene image, the correction unit does not perform brightness correction processing or performs brightness correction processing by a relatively moderate correction degree in comparison with image data that is judged as not being a night scene image.

6. The image processing apparatus according to claim 1, wherein the correction unit performs color-balance correction processing that equalizes deviation of distribution between every element color that constitutes the image data, and wherein, with respect to image data that is judged as being a night scene image, the correction unit does not perform color-balance correction or performs color-balance correction by a relatively moderate correction degree in comparison with image data that is judged as not being a night scene image.

7. An image processing method that performs correction processing with respect to image data, the method comprising:
judging whether an image represented by the image data is a night scene image;
correcting the image data that is judged as being a night scene image from the result of the judging by relatively strengthening a degree of expansion of luminosity range in comparison with image data that is judged as not being a night scene image, so that the brightness range of the image data is enlarged.

8. An image processing program embodied in a computer-readable medium that causes a computer to execute correction processing with respect to image data, the processing comprising:
a night scene judgment function that judges whether an image represented by the image data is a night scene; and
a correction function that performs correction processing with respect to the image data that is judged as a night scene image by the night scene judging function by relatively strengthening a degree of expansion of luminosity range in comparison with image data that is judged as not being a night scene image, so that the brightness range of the image data is enlarged.
